(19) United States
(12) Patent Application Publication
(10) Pub. No.: US 2004/0175622 A9
(43) Pub. Date: Sep. 9, 2004

(54) Method of preparing electrode composition having a carbon-containing-coated metal oxide, electrode composition and electrochemical cell

(76) Inventors: Zhendong Hu, Ann Arbor, MI (US); Yong Che, Ann Arbor, MI (US)

Correspondence Address: Platon N. Mandros, BURNS, DOANE, SWECKER & MATHIS, L.L.P., P.O. Box 1404, Alexandria, VA, 22313-1404, US

(21) Appl. No.: 10/133,494

(22) Filed: Apr. 29, 2002

(51) Int. Cl. H01M 4/62; B05D 5/12; H01M 4/48

(52) U.S. Cl. 429/232; 429/217; 429/231.5; 427/122

(57) ABSTRACT

Provided is a novel method of forming an electrode composition suitable for use in an electrochemical cell. The method involves (a) forming a carbon-containing coating on a metal-oxide material; and (b) forming an electrode paste or slurry from components comprising a solvent, a polymeric binder material and the coated metal-oxide material. Also provided is an electrode composition suitable for use in an electrochemical cell. The electrode composition includes a polymeric binder material and an active material. The active material includes a metal oxide with a carbon-containing coating thereon. Also provided is an electrochemical cell which includes an electrode formed from the electrode composition. The invention results in an electrochemical cell having improved charge-discharge cycle life and improved coulomb efficiency.

### BACKGROUND OF THE INVENTION

1. Field of the Invention

The invention relates to methods of forming an electrode composition suitable for use in an electrochemical cell. The invention also relates to electrode compositions suitable for use in an electrochemical cell, and to electrochemical cells. The invention has particular applicability to the manufacture of secondary non-aqueous power sources.

2. Description of the Related Art

Secondary non-aqueous electrochemical cells (also called batteries) are typically composed of an anode, a cathode, a separator and an electrolyte. Lithium metal has conventionally been used as an anode material in such cells. Upon charge/discharge cycling of these cells, however, the lithium metal becomes deposited as mossy dendritic structures on the anode. These dendrites can break away from the surface of the anode, thus isolating active electrode material and reducing the capacity of the anode. The dendrites further can penetrate through the cell's separator, thus short circuiting the cell.

In order to eliminate such problems, carbon intercalation anode materials such as LiₓC₆ have been developed. When these carbon materials are charged appropriately, lithium ions are not deposited as mossy dendrites. Instead, the lithium ions are intercalated into the carbon structure. When these anodes are discharged, the lithium ions are de-intercalated from the carbon. However, these materials also suffer various disadvantages. For example, once the carbon galleries are filled to capacity with lithium ions, continued charging of the anode results in the deposition of mossy dendritic lithium metal at the surface of the carbon. As with the metallic lithium anodes described above, these dendrites can break away from the anode and/or short circuit the cell. Furthermore, the performance of carbon anode materials at high temperatures degrades due to exfoliation caused by mechanical stress upon repeated lithium intercalation and de-intercalation.

In consideration of these factors, metal-oxide intercalation compounds have been considered as reversible anode materials, for example, Li₄Ti₅O₁₂, WO₂, and LiFeO₂. Unlike carbon, tungsten (IV) oxide (WO₂) is not flammable and no dendrites are formed even at high charge/discharge rates. While these properties are particularly beneficial for high rate applications, the capacity of a WO₂ electrode has been found to disadvantageously degrade with cycle lifetime.

In developing lithium secondary batteries, the inventors attempted various combinations of different cathode and anode active materials. For example, an LiMn₂O₄ cathode and WO₂ anode combination was attempted, as were combinations based on an LiMn₂O₄ cathode and a carbonaceous material, such as graphite, meso carbon micro bead (MCMB), and hard carbon, as anode. Despite the safety benefit of using WO₂ as an anode material in a lithium secondary battery, the combination of WO₂/LiMn₂O₄ was found to generate more gas during a lifetime test under elevated temperature than the combination of carbon/LiMn₂O₄. This phenomenon indicates that the WO₂ electrode is less stable than the carbonaceous electrode in the non-aqueous electrolyte solution because the gas is the decomposition product of the non-aqueous solvent(s) in the electrolyte solution. A widely accepted theory for lithium batteries indicates that the non-aqueous solvent(s) in the battery electrolyte tends to decompose on the surface of the anode electrode when charging a lithium secondary battery. The products may include, for example, Li-alkoxides (ROLi), ROCO₂Li and CO₂ gas. Fortunately, the solid part of the decomposition products deposit on the surface of the anode materials to form a stable layer of dense film called a solid electrolyte interface (SEI). The SEI film prevents further decomposition of the electrolyte solvent. It is believed that the lower stability of WO₂ as an anode material in lithium secondary batteries might indicate that the SEI film on WO₂ particles is less stable than on a carbon electrode.

It is most desirable that electrochemical cells have a long lifetime, particularly when used in applications including electronics devices, such as mobile phones and laptop computers, and electric and hybrid electric vehicles. The stable performance of electrode materials is one of the key factors in maximizing battery lifetime.

To overcome or conspicuously ameliorate the disadvantages of the related art, it is an object of the present invention to provide methods of forming an electrode composition suitable for use in an electrochemical cell. The electrode compositions include an active material which comprises a metal oxide with a carbon-containing coating thereon. The electrodes formed with the inventive composition exhibit improved charge-discharge capacity per unit weight of the electrode active material, and are additionally chemically and electrochemically stable.

It is a further object of the invention to provide electrode compositions suitable for use in an electrochemical cell.

It is a further object of the invention to provide electrochemical cells which include the electrode compositions. Other objects, advantages and aspects of the present invention will become apparent to one of ordinary skill in the art on a review of the specification, drawings and claims appended hereto.

### SUMMARY OF THE INVENTION

According to a first aspect of the invention, provided is a novel method of forming an electrode composition suitable for use in an electrochemical cell. The method comprises: (a) forming a carbon-containing coating on a metal-oxide material; and (b) forming an electrode paste or slurry from components comprising a solvent, a polymeric binder material and the coated metal-oxide material.

In accordance with further preferred aspects of the method, a coating is formed of the electrode paste or slurry, and the solvent is evaporated. The metal-oxide material can be any metal-oxide active material which is capable of lithium ion intercalation, for example, a tungsten-oxide, a tin-oxide, a vanadium-oxide, a titanium-oxide, a molybdenum-oxide, or combinations thereof.

In accordance with a preferred aspect of the invention, the carbon-containing coating is formed by chemical vapor deposition (CVD). The chemical vapor deposition typically comprises introducing a carbon-containing material into a chemical vapor deposition reactor, for example, a tube furnace. The carbon-containing material is typically a hydrocarbon gas or vapor of an organic solvent, such as propane, toluene, methanol, acetone, hexane, benzene, xylene, methylnaphthalene, or a combination thereof. The carbon-containing coating typically contains greater than 90% by weight carbon. The coating can be amorphous carbon. The chemical vapor deposition is typically conducted at a temperature of from 600 to 1000° C.

According to a further aspect of the invention, provided is an electrode composition suitable for use in an electrochemical cell. The electrode composition comprises a polymeric binder material and an active material. The active material comprises a metal oxide with a carbon-containing coating thereon.

In accordance with yet a further aspect of the invention, provided is an electrochemical cell. The electrochemical cell comprises an anode, a cathode and an electrolyte providing a conducting medium between the anode and the cathode. The anode or the cathode comprises an electrode composition comprising a polymeric binder material and an active material. The active material comprises a metal oxide with a carbon-containing coating thereon.

### BRIEF DESCRIPTION OF THE DRAWINGS

The objects and advantages of the invention will become apparent from the following detailed description of the preferred embodiments thereof in connection with the accompanying drawings, in which like numerals designate like elements, and in which:

FIG. 1 is a schematic diagram of an exemplary electrochemical cell in accordance with one aspect of the invention;

FIG. 2 shows X-ray diffraction patterns for carbon-containing-coated and uncoated 5 μm WO₂ particles;

FIG. 3 is a graph of discharge capacity versus number of cycles for a comparative electrode comprising uncoated 5 μm WO₂ particles and an electrode in accordance with the invention comprising carbon-containing-coated 5 μm WO₂ particles;

FIG. 4 is a graph of coulomb efficiency versus number of cycles for a comparative electrode comprising uncoated 5 μm WO₂ particles and an electrode in accordance with the invention comprising carbon-containing-coated 5 μm WO₂ particles;

FIG. 5 shows X-ray diffraction patterns for carbon-containing-coated and uncoated 40 μm WO₂ particles;

FIG. 6 is a graph of discharge capacity versus number of cycles for a comparative electrode comprising uncoated 40 μm WO₂ particles and an electrode in accordance with the invention comprising carbon-containing-coated 40 μm WO₂ particles; and

FIG. 7 is a graph of coulomb efficiency versus number of cycles for a comparative electrode comprising uncoated 40 μm WO₂ particles and an electrode in accordance with the invention comprising carbon-containing-coated 40 μm WO₂ particles.

### DETAILED DESCRIPTION OF THE PREFERRED EMBODIMENTS OF THE INVENTION

The electrode composition in accordance with the invention includes a carbon-containing-coated metal-oxide active material. The material is a composite which preferably includes a thin carbon-containing layer, for example, of carbonaceous material coated onto the surface of the metal-oxide particles. A solid electrolyte interface (SEI) film is deposited on the coated layer instead of being deposited directly in contact with the metal oxide as in previously described methods. This SEI film will therefore be more stable and the electrode will have a more stable performance. In particular, the coated material is effective to increase the charge-discharge capacity per unit weight of the electrode active material, as well as providing improved coulomb efficiency when compared with cells employing an un-coated electrode material.

The metal oxide can be any metal oxide which is capable of Li-ion intercalation, for example, a tungsten oxide (e.g., tungsten (IV) oxide), a vanadium oxide (e.g., V₂O₅), a titanium oxide (e.g., TiO₂), a molybdenum oxide (e.g., MoO₂), or combinations thereof Of these, tungsten (IV) oxide is preferred. The particle size of the powder is typically from about 1 to 100 μm, preferably from about 5 to 40 μm.

Methods for forming the coated metal oxide electrodes in accordance with the invention will now be described. The methods allow for the preparation of electrodes and electrochemical cells having desired charge-discharge capacity per unit mass of the electrode active materials, as well as providing improved coulomb efficiency. In addition, the methods allow for control of the physical characteristics of the resultant material. For example, the materials may be fabricated to comprise materials of variable particle sizes, including submicron sized particles having high surface area. This eliminates additional material processing steps, such as grinding, sieving, etc., which are typically required to fabricate electrodes, particularly in all solid state systems.

Various coating methods can be employed in forming the carbon-containing coating. For example, chemical vapor deposition (CVD) methods such as atmospheric pressure CVD (APCVD), low pressure CVD (LPCVD), plasma enhanced CVD (PECVD), and pulsed laser CVD (PLCVD), or physical vapor deposition (PVD) methods such as sputtering and evaporation are envisioned, with CVD being preferred. Such methods including proper selection of process materials such as reactant gases and liquide, carrier gases, sputtering targets, and evaporation sources as well as process conditions can be understood by persons skilled in the art based on the present specification.

Without being limited thereto, an exemplary method in accordance with the invention will be described with reference to a chemical vapor deposition method, specifically to an LPCVD quartz or silicon carbide tube furnace. It should, however, be clear that any of the aforementioned deposition or other techniques can be employed without departing from the invention as long as the desired carbon-containing film can be deposited on the surface of the metal-oxide material.

The tube furnace is typically connected to a vacuum pump to allow evacuation of the tube. One or more gas inlets are also provided which allow an inert gas and a CVD reactant gas to be introduced into the process tube. The CVD reactant gas can be provided from a gas cylinder or from a liquid source by use of a bubbler or vaporizer. The gas outlet of the tube furnace is preferably connected to an oil bubbler to prevent air from entering the furnace. The metal-oxide powder is introduced into the tube, for example, in an alumina tray with a powder mass of from about 5 to 20 grams, preferably from about 10 to 20 grams. The tube furnace is evacuated to a pressure of less than about 500 microns Hg and is then backfilled with a carrier gas to about atmospheric pressure. Suitable carrier gases include, for example, helium, nitrogen, carbon dioxide, and argon, with argon being preferred. The carrier gas flow rate at this step is typically from about 10 to 100 ml/min, preferably from about 20 to 40 ml/min.

While flowing the carrier gas into the furnace, the temperature is increased from ambient temperature to a temperature effective for chemical vapor deposition to occur, preferably from about 600 to 1000° C., more preferably from about 650 to 850° C. When the temperature of the furnace becomes stabilized, a suitable hydrocarbon material which allows formation of the carbon-containing coating is introduced into the chamber with or without the carrier gas. Suitable hydrocarbon materials include, for example, propane, toluene, methanol, acetone, hexane, benzene, xylene, methylnaphthalene, and combinations thereof. Of these, propane and toluene are preferred hydrocarbon materials.

The carrier gas flow rate is typically less than about 40 ml/min, preferably from about 20 to 40 ml/min. The hydrocarbon flow rate is typically from about 10 to 40 ml/min, preferably from about 20 to 40 ml/min. The time period for CVD/pyrolysis is typically from about 20 minutes to 8 hours, preferably from about 2 to 4 hours. The pyrolysis step results in the formation of a thin carbon-containing coating on the metal-oxide powder. The carbon-containing coating is believed to be a carbon coating, for example, an amorphous carbon coating. The coating may have a carbon content, for example, of greater than 90% by weight. The coating weight is typically less than 10% by weight, preferably less than 5% by weight, based on the coated metal-oxide material. The coating thickness will depend on the conditions of the CVD/pyrolysis step, and should be effective to substantially or completely cover the surface of the metal oxide.

Following the pyrolysis step, the flow of the hydrocarbon material into the tube is stopped and the tube furnace is allowed to cool down. During the cooling step, the carrier gas continues to flow through the tube, typically at a flow rate of from about 10 to 100 ml/min, preferably from about 20 to 40 ml/min. After the temperature of the furnace decreases to about ambient temperature, the coated powder is removed from the tube furnace. The resulting coated powder can then be used to form, through conventional techniques, an electrode composition which can be used in an anode or cathode in an electrochemical cell, typically for an electrode of a lithium secondary battery.

A method for preparing the electrode from the coated metal-oxide powder will now be described. An electrode paste or slurry is formed by mixing together a binder, a solvent and the coated metal-oxide powder. Optionally, a conductive carbon material can be added. Typical binders include, for example, polyvinylidene fluoride (PVDF) and TEFLON powder. The solvent can be, for example, 1-methyl-2-pyrrolidinone, dimethyl sulfoxide, acetonitrile, and dimethyl formate. The conductive carbon material can be, for example, acetylene black conductive carbon, graphite or other known materials. Typically, the binder is first added to and mixed with the solvent. This is followed by addition of the conductive carbon material and mixing. Next, the coated metal-oxide is added and mixed to form a thick paste or slurry. The paste or slurry is coated on a smooth, flat surface, and a desired thickness (e.g., from about 0.001 to 0.01 inch) is obtained by use of a suitable tool such as a doctor blade. The material is then dried, preferably under vacuum, at from about 130 to 170° C., preferably about 150° C., for a period of from about 6 to 15 hours.

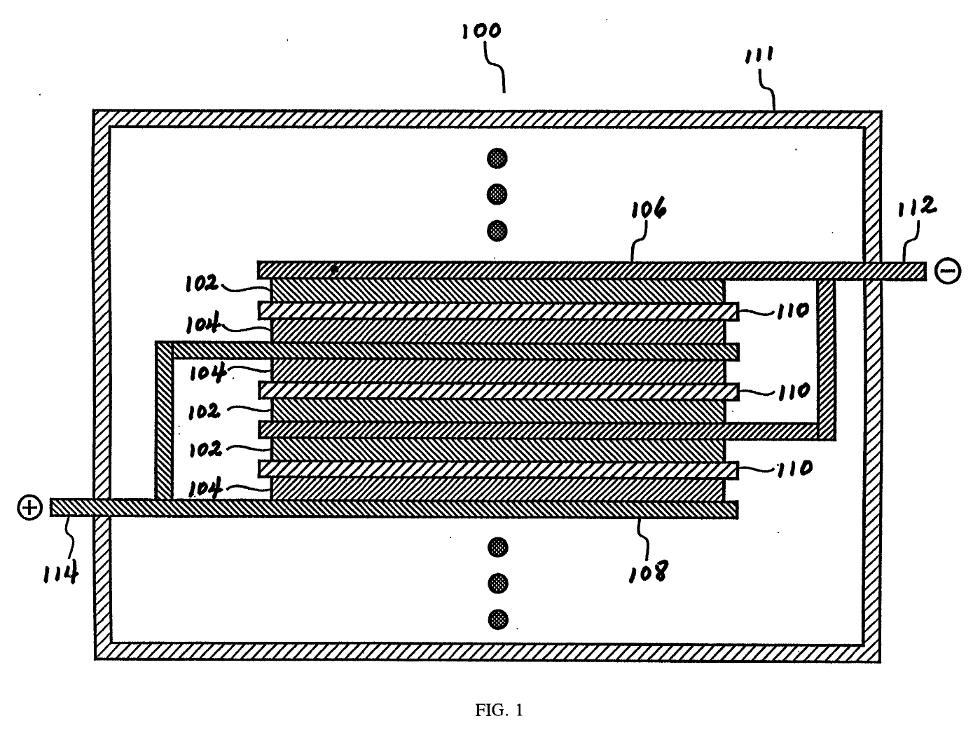

The electrode in accordance with the invention can be employed in an electrochemical cell as an anode or a cathode. With reference to FIG. 1, an exemplary electrochemical cell 100 in accordance with the invention will now be described. A series of anodes 102 and an equal number of cathodes 104 typically of the same thickness are formed on anode and cathode current collectors 106, 108, respectively. Either the anode or cathode is constructed from the metal oxide material described above. The other of the anode or cathode is formed of a suitable electrode material, for example, metallic lithium anode or other conventional material. Suitable materials for the current collectors are known and include, for example, aluminum, copper or nickel, for the anode current collector, and aluminum for the cathode current collector.

The anodes or cathodes are typically formed on opposite surfaces of the anode current collectors 106 or cathode current collectors 108, respectively. As shown, a separator 110 is formed for each of the anode-cathode pairs to prevent contact between the anodes 102 and cathodes 104 in the final structure. Suitable separator materials are known in the art and include, for example, Celgard® 3501, commercially available from Hoechst Celanese.

The anodes 102 and cathodes 104 are alternately stacked in an array as shown. The electrochemical cell 100 is placed into a container 111, such as a plastic bag, and the anode and cathode current collectors 106, 108 are each connected to a respective terminal or electrical feedthrough 112, 114 in the container. Electrolyte is then added to the cell, and the cell is sealed. Optionally, the electrolyte can be filled after pulling a vacuum on the interior of container 111. Suitable electrolytes are known in the art and include, for example, LiPF₆ in ethylene carbonate (EC) and diethylcarbonate (DEC) or in ethylene carbonate (EC) and dimethylcarbonate (DMC). Other known, non-aqueous electrolytes those are suitable for lithium cells can alternatively be employed.

The performance of metal-oxide electrodes can be evaluated through the performance of a Li/metal-oxide cell with a non-aqueous electrolyte. When the Li/metal-oxide cell is discharged, the lithium ions intercalate into the crystal structure of the metal-oxide. Solvent might decompose on the surface of the metal-oxide if there is no stable solid electrolyte interface on the surface of the metal-oxide. When the Li/metal-oxide cell is charged, the lithium ions inside the metal-oxide structure leave the metal-oxide structure (de-intercalate). The coulomb efficiency is the ratio of the de-intercalation capacity to the intercalation capacity. The more stable the solid electrolyte interface on the metal-oxide particles, the higher the coulomb efficiency will be for the Li/metal-oxide cell.

In order to further illustrate the present invention and the advantages thereof, the following specific examples are given, it being understood that same are intended only as illustrative and in nowise limitative. The following examples demonstrate the surprising and unexpected results which can be achieved through the invention by use of a carbon-containing-coated metal oxide material as an active electrode material.

### COMPARATIVE EXAMPLE 1

1. Preparation of WO₂ Powder with 5 μm Particle Size

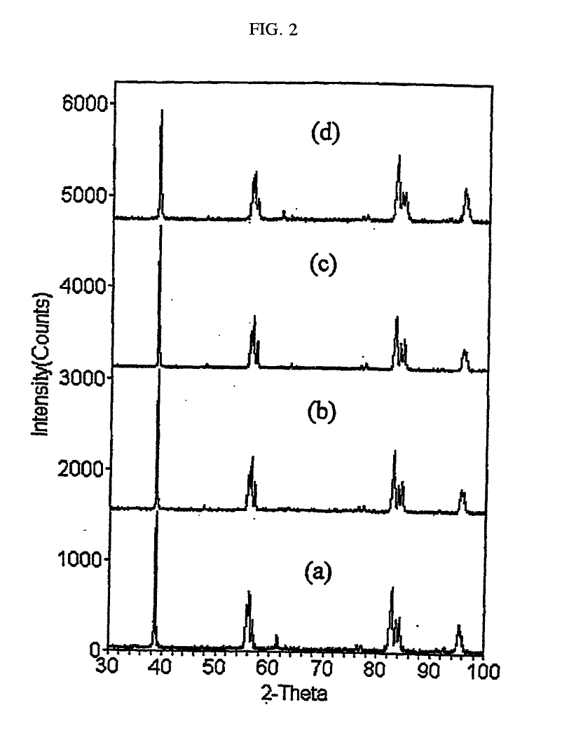

Tungsten (IV) oxide (WO₂) powder having a 5 μm particle size, from Beijing Jinxinhe Science & Trade Co., Ltd. (BJST), Beijing, China, was used in this comparative example. The X-ray diffraction pattern of the material was measured with a Rigaku MiniFlex X-ray Diffractometer with a chromium cathode. The resulting diffraction pattern is shown in FIG. 2(a), and is further described in numerical form in Table I below. From FIG. 2(a), it can be understood that the WO₂ material contained a trace amount of metallic tungsten.

The WO₂ was next baked at 750° C. for 2 hours in air in a General Signal Co. Lidberg/Blue M, model 15842 oven and was thus converted to WO₃. The WO₃ was then baked in a Barnstead/Thermodyne 21100 quartz tube furnace at 800° C. for 24 hours using a flow of argon gas containing 5% hydrogen (Ar/5%H₂). The WO₃ was thus reduced back to WO₂. The purpose of this two-step process was to first oxidize the trace amount of metallic tungsten, and then to convert the WO₃ to WO₂ without changing the particle size distribution of the powder. The X-ray diffraction pattern of the resulting material was measured. The resulting diffraction pattern is shown in FIG. 2(b), and is further described in numerical form in Table I. The X-ray diffraction pattern of the reduced WO₂ powder shows only the pattern for WO₂ and no pattern for metallic tungsten, indicating complete conversion of the trace metallic tungsten and the WO₃ to WO₂.

2. Preparation of Electrodes, Cells and Evaluation

0.35 g of polyvinylidene fluoride (PVDF-741, made by Elf Atochem of Philadelphia, Pa.) was dissolved in 5.5 g of 1-methyl-2-pyrrolidinone at 80° C. 0.4 g of Chevron acetelyne black conductive carbon was added and mixed well. Finally, 4.25 g of the reduced WO₂ powder was added and mixed well to form a thick paste to slurry. Using a doctor blade, thin (0.001 to 0.010 inch) electrode sheets were fabricated. The electrodes were then dried under vacuum at 150° C. for 6-15 hours.

The electrochemical performance of the tungsten oxide electrode material was evaluated by fabricating an electrochemical cell as illustrated in FIG. 1. A series of 0.010 inch thick metallic lithium anodes 102 and an equal number of cathodes 104 of the same capacity equivalent thickness, constructed from the tungsten oxide material of Comparative Example 1, were used to construct the cell. Copper and aluminum foils were used as anode and cathode current collectors 106, 108. Celgard® 3501, commercially available from Hoechst Celanese, was used to form a separator 110 between each of the anode/cathode pairs.

Each of the separators was formed with two 0.001 inch thick layers of the material. Cells having an electrode area of 12.7 cm² were packaged in plastic bags and sealed after activation with 1.0 M LiPF₆ in ethylene carbonate (EC) and diethylcarbonate (DEC) solutions (1:1) as the electrolyte. Other known, non-aqueous electrolytes that are suitable for lithium cells can also be employed.

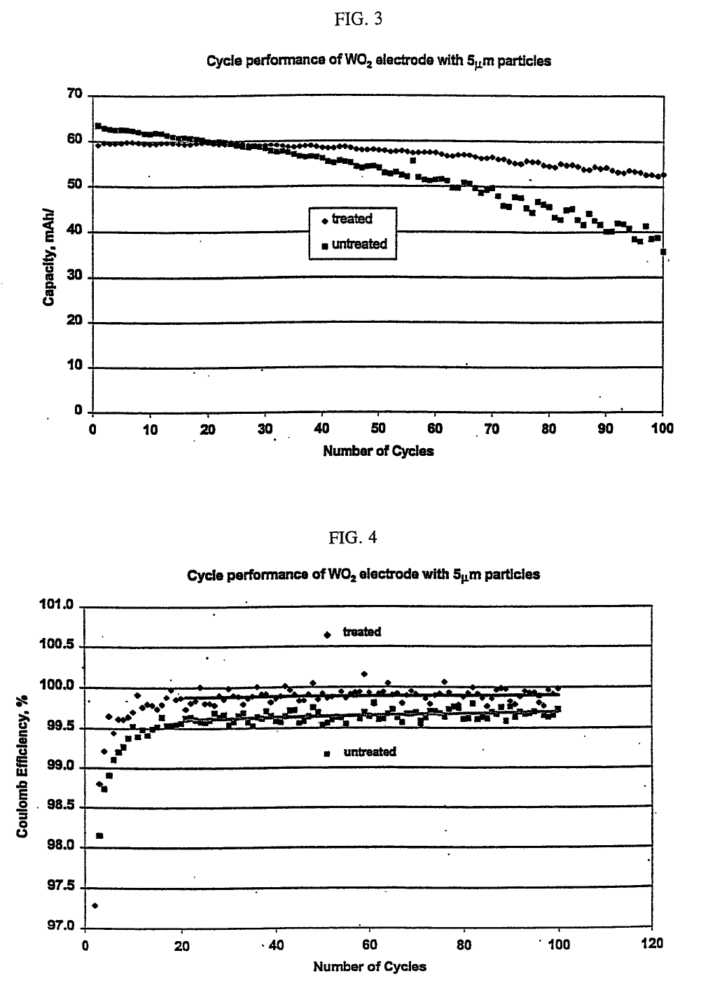

The cell was then repeatedly discharged and charged, and the capacity fade characteristics of the cell were determined. From a starting voltage of about 3.2V, the discharge was allowed to proceed with a current of 10 mA until a minimum voltage of 0.7V was reached. The cell voltage was held at 0.7 V until the current through the cell dropped to less than 1 mA, at which time the cell was charged to 3V with a current of 5 mA. The results are shown as “untreated” in FIG. 3, which is a graph of charge capacity versus number of cycles.

The coulomb efficiency for the cell was calculated as the ratio of the charge capacity divided by the discharge capacity. The results are shown as “untreated” in FIG. 4, which is a graph of coulomb efficiency versus number of cycles.

### EXAMPLE 1

1. Preparation of Coated WO₂ Powder with 5 μm Particle Size

10.000 g of the reduced 5 μm WO₂ powder from Comparative Example 1 was placed in a tube furnace and coated with carbon by CVD as follows. After evacuating the tube furnace for about 30 minutes to about 500 microns Hg, the tube was flushed with argon gas at a rate of 40 ml/min while raising the temperature of the furnace from 25° C. to 700° C. in 30 minutes. Propane gas was next introduced into the tube furnace at a flow rate of 40 ml/min together with argon gas at a flow rate of 20 ml/min. The WO₂ powder was baked at 700° C. in the propane/argon flow for 4 hours, and then cooled to room temperature by turning off the furnace heater, with an argon flow of 20 ml/min and no propane flow.

Visual examination of the powder after pyrolysis showed the powder as having a dark brown color, indicating that the surface of the metal oxide underwent a change By mass analysis, it was determined that the mass of the powder increased by 0.4%. The X-ray diffraction pattern of the pyrolyzed material was measured. The resulting diffraction pattern is shown in FIG. 2(c), and is further described in numerical form in Table I. Upon review of these results, it can be seen that there was no change in the X-ray diffraction pattern of the powder after the CVD treatment. Based on the X-ray diffraction and mass analysis data, it is hypothesized that the base WO₂ powder remained unchanged, but was covered with a coating. Based on the experimental conditions, it is also hypothesized that the coating was a thin, amorphous carbon layer, as carbon does not crystallize at temperatures between 600 and 1000° C., but is in an amorphous state. Due to the thinness of the layer, carbon was not detected by the X-ray diffraction measurement.

2. Preparation of Electrodes, Cells and Evaluation

The same procedure described above with reference to Comparative Example 1 was used to prepare electrodes and cells, and to evaluate same using the 5 μm CVD-coated tungsten oxide. The results are shown as “treated” in FIGS. 3 and 4.

### EXAMPLE 2

Preparation of Coated WO₂ Powder with 5 μm Particle Size Using Toluene

15 g of tungsten (IV) oxide powder from BJST having a 5 μm particle size was placed in a tube furnace. After evacuating the tube furnace for about 30 minutes to about 500 microns Hg, the tube was flushed with argon gas at a rate of 40 ml/min while raising the temperature of the furnace from 25° C. to 700° C. in 30 minutes. Prior to its being introduced into the tube, the argon gas was passed through a gas bubbler containing liquid toluene. The toluene was maintained at ambient temperature during the furnace temperature ramp-up. When the furnace temperature became stabilized at 700° C., the temperature of the bubbler containing the toluene was increased to 105° C., thus increasing the vapor pressure of the toluene. The flow rate of the argon was set at 20 ml/min, thus creating a mixture of argon and toluene which was introduced into the tube. Pyrolysis was continued for twenty-two hours, during which time 26 g of toluene was consumed.

Visual examination of the powder after pyrolysis showed the powder as having a dark brown color, indicating that the surface of the metal oxide was changed. By mass analysis, it was determined that the mass of the powder increased by 2.9%, indicating that a coating was formed on the powder. It is believed that the coating was a thin, amorphous carbon layer. The X-ray diffraction pattern of the pyrolyzed material was measured. The resulting diffraction pattern is shown in FIG. 2(d), and is further described in numerical form in Table I. Upon review of these results, it can be seen that there was no change in the X-ray diffraction pattern of the powder after the CVD treatment.

### COMPARATIVE EXAMPLE 2

1. Preparation of WO₂ Powder with 40 μm Particle Size

Tungsten (IV) oxide (WO₂) with 100-mesh particle size, from Cerac Inc., Milwaukee, Wis., was re-sieved with a 400-mesh sieve. Only that part of the powder which passed through the 400-mesh sieve was collected as the 40 μm particle size powder. 20 g of the 40 μm WO₂ powder were placed in a tube furnace. After evacuating the tube furnace for about 30 minutes to about 500 microns Hg, the tube was flushed with argon gas at a rate of 40 ml/min while raising the temperature of the furnace from 25° C. to 700° C. in 30 minutes. The tube furnace was maintained at 700° C. for 4 hours with an argon flow rate of 40 ml/min.

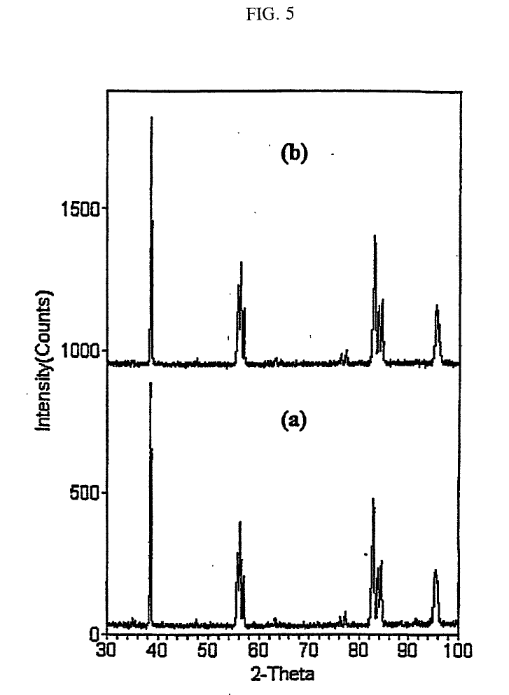

By mass analysis, it was determined that the mass of the powder did not change from that of pre-treated powder. The X-ray diffraction pattern of the heated material was measured. The resulting diffraction pattern is shown in FIG. 5(a), and is further described in numerical form in Table 2 below.

2. Preparation of Electrodes, Cells and Evaluation

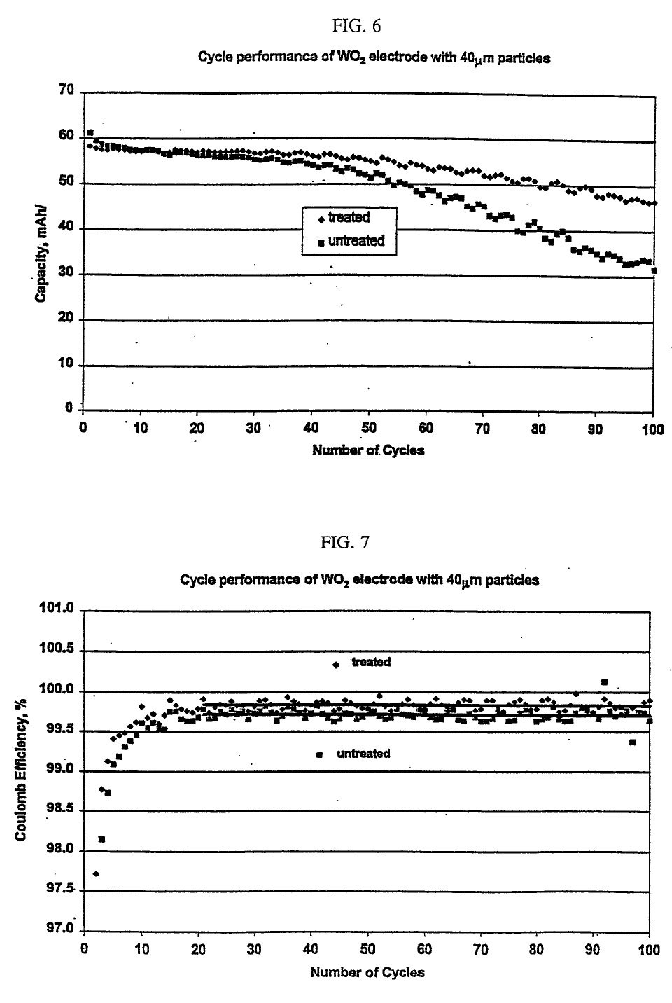

The same procedure described above with reference to Comparative Example 1 was used to prepare electrodes and cells, and to evaluate same using the sieved 40 μm tungsten oxide. The results are shown as “untreated” in FIGS. 6 and 7. FIG. 6 is a graph of discharge capacity versus number of cycles, and FIG. 7 is a graph of coulomb efficiency versus number of cycles.

### EXAMPLE 3

1. Preparation of Coated WO₂ Powder with 40 μm Particle Size

The same procedure described above in Example 1 for preparation of the CVD-treated WO₂ powder with 5 μm particle size was repeated, except using the above-described re-sieved Cerac WO₂ powder having 40 μm particle size.

Visual examination of the powder after pyrolysis showed the powder as having a dark brown color, indicating that the surface of the brown powder was changed. By mass analysis, it was determined that the mass of the powder increased by 0.14%, indicating the formation of a coating on the powder surface. The X-ray diffraction pattern of the pyrolyzed material was measured. The resulting diffraction pattern is shown in FIG. 5(b), and is further described in numerical form in Table 2. Upon review of these results, it can be seen that there was no change in the X-ray diffraction pattern of the powder after the CVD treatment. Based on the X-ray diffraction and mass analysis data, the base WO₂ powder remained unchanged, but was covered with a coating. Based on the experimental conditions, it is also hypothesized that the coating was a thin, amorphous carbon layer, as carbon does not crystallize at temperatures between 600 and 1000° C., but is in an amorphous state, and cannot be detected by the X-ray analysis. Due to the thinness of the layer, carbon was not detected by the X-ray diffraction measurement.

2. Preparation of Electrodes, Cells and Evaluation

The same procedure described above with reference to Comparative Example 1 was used to prepare electrodes and cells, and to evaluate same using the 40 μm coated tungsten oxide. The results are shown as “treated” in FIGS. 6 and 7.

TABLE I
X-ray Diffraction Data

| | | WO₂ (c) | |
|---|---|---|---|
| WO₂ (a) | WO₂ (b) | C₃H₈ | WO₂ (d) |
| BJST | Reduced | CVD-treated | C₇C₈ CVD-treated |

| d(A) | I | d(A) | I | d(A) | I | d(A) | I |
|---|---|---|---|---|---|---|---|
| 3.7965 | 2 | | | | | | |
| 3.4516 | 100 | 3.4519 | 100 | 3.4516 | 100 | 3.4543 | 100 |
| 2.8284 | 2 | 2.8315 | 3 | 2.8291 | 3 | 2.8339 | 3 |
| 2.4444 | 34 | 2.4424 | 27 | 2.4424 | 26 | 2.4426 | 37 |
| 2.4265 | 39 | 2.4242 | 36 | 2.4229 | 32 | 2.4249 | 41 |
| 2.3995 | 21 | 2.3975 | 20 | 2.3961 | 18 | 2.3994 | 18 |
| 2.2364 | 9 | | | | | 2.2379 | 8 |
| 2.1863 | 2 | 2.1849 | 2 | 2.1834 | 3 | 2.1863 | 4 |
| | | 2.1543 | 1 | 2.1515 | 1 | | |
| 1.8514 | 3 | 1.8525 | 3 | 1.8540 | 2 | 1.8543 | 3 |
| 1.8331 | 3 | 1.8329 | 4 | 1.8329 | 4 | 1.8331 | 4 |
| 1.7278 | 46 | 1.7278 | 43 | 1.7271 | 37 | 1.7270 | 58 |
| 1.7140 | 9 | 1.7128 | 13 | 1.7133 | 12 | 1.7126 | 13 |
| 1.7035 | 20 | 1.7019 | 21 | 1.7019 | 20 | 1.7020 | 25 |
| 1.5803 | 3 | | | | | | |
| 1.5963 | 2 | 1.5976 | 1 | | | | |
| 1.5454 | 20 | 1.5460 | 15 | 1.5466 | 13 | 1.5460 | 28 |
| | | 1.5412 | 13 | 1.5418 | 13 | | |

TABLE II
X-ray Diffraction Data

| WO₂ (a) | | WO₂ (b) | |
|---|---|---|---|
| CERAC | | C₃H₈ CVD-treated | |
| d(A) | I | d(A) | I |
| 3.7870 | 3 | | |
| 3.4545 | 100 | 3.4555 | 100 |
| 2.8340 | 3 | 2.8340 | 2 |
| 2.4443 | 30 | 2.4426 | 32 |
| 2.4245 | 38 | 2.4247 | 37 |
| 2.3978 | 20 | 2.3994 | 23 |
| 2.1863 | 3 | 2.1846 | 3 |
| | | 2.0263 | 2 |
| 1.8516 | 4 | 1.8534 | 4 |
| 1.8312 | 6 | 1.8337 | 5 |
| 1.7278 | 51 | 1.7278 | 52 |
| 1.7134 | 15 | 1.7140 | 16 |
| 1.7020 | 26 | 1.7020 | 26 |
| 1.5989 | 3 | | |
| 1.5460 | 22 | 1.5460 | 22 |
| 1.5418 | 18.7 | | |

As can be seen from FIGS. 3, 4, 6 and 7, improved capacity and coulomb efficiency over the lifetime of the cell can be achieved with cells constructed from electrodes comprising a carbon-containing-coated metal oxide in accordance with the invention.

In particular, FIGS. 3 and 6 show that significant capacity improvements with the carbon-containing-coated metal oxides were achieved. When cells were cycled, the capacity fade of cells with non-coated metal oxides was greater than the cells with the coated metal oxides. FIGS. 4 and 7 demonstrate that a greater coulomb efficiency can be achieved for cells which include electrodes comprising a carbon-containing-coated metal oxide than for those comprising a non-coated metal oxide. Such improved coulomb efficiency is indicative of a stable solid electrolyte interface on the metal-oxide particles.

In summary, the use of a carbon-containing-coated metal oxide in an electrode of an electrochemical cell can significantly improve the cycleability of the electrode.

A wide range of uses are envisioned for the electrodes and electrochemical cells in accordance with the present invention. For example, without being limited in anyway thereto, the invention is particularly applicable to the following applications. The inventive electrodes and cells can be used, for example, as a battery in cellular or other forms of mobile telephones; in electrically powered vehicles such as a pure electric vehicle, a hybrid electric vehicle or a power assisted electric vehicle (e.g., automobiles, trucks, mopeds, motorcycles powered by an engine and a battery or by a fuel cell and a battery); in medical devices; in power tools; and in security systems such a personal computer or building security systems; in security cards or credit cards which use an internal power supply. In general, the invention is applicable to any type of device where a capacitor or battery are used. Furthermore, the materials of the invention can be used as either a cathode or anode active material.

While the invention has been described in detail with reference to specific embodiments thereof, it will be apparent to one skilled in the art that various changes and modifications can be made, and equivalents employed, without departing from the scope of the appended claims.

What is claimed is:

1. A method of forming an electrode composition suitable for use in an electrochemical cell, comprising:
(a) forming a carbon-containing coating on a metal-oxide material; and
(b) forming an electrode paste or slurry from components comprising a solvent, a polymeric binder material and the coated metal-oxide material.

2. The method according to claim 1, further comprising:
(c) forming a coating of the electrode paste or slurry; and
(d) evaporating the solvent.

3. The method according to claim 1, wherein the transition metal-oxide material is a tungsten-oxide, a tin-oxide, a vanadium-oxide, a titanium-oxide, a molybdenum-oxide, or combinations thereof.

4. The method according to claim 1, wherein the carbon-containing-coating is formed by a chemical vapor deposition method.

5. The method according to claim 4, wherein the chemical vapor deposition method comprises introducing a carbon-containing material into a chemical vapor deposition reactor, wherein the carbon-containing material is propane, toluene, methanol, acetone, hexane, benzene, xylene, methylnaphthalene, or a combination thereof.

6. The method according to claim 1, wherein the chemical vapor deposition is conducted at a temperature of from 650 to 850° C.

7. The method according to claim 1, wherein the carbon-containing coating is formed by physical vapor deposition or evaporation.

8. The method according to claim 1, wherein the carbon-containing coating comprises at least 90% by weight carbon.

9. The method according to claim 8, wherein the carbon-containing coating is amorphous carbon.

10. An electrode composition suitable for use in an electrochemical cell, 110 comprising a polymeric binder material and an active material, wherein the active material comprises a metal oxide with a carbon-containing coating thereon.

11. The electrode composition according to claim 10, wherein the metal-oxide material is a tungsten-oxide, a tin-oxide, a vanadium-oxide, a titanium-oxide, a molybdenum-oxide, or combinations thereof.

12. The electrode composition according to claim 10, wherein the carbon-containing coating comprises at least 90% by weight carbon.

13. The electrode composition according to claim 12, wherein the carbon-containing coating is amorphous carbon.

14. An electrochemical cell, comprising:
an anode, a cathode and an electrolyte providing a conducting medium between the anode and the cathode, wherein the anode or the cathode comprises an electrode composition comprising a polymeric binder material and an active material, wherein the active material comprises a metal oxide with a carbon-containing coating thereon.

15. The electrochemical cell according to claim 14, wherein the metal-oxide material is a transition metal-oxide.

16. The electrochemical cell according to claim 14, wherein the transition metal-oxide material is a tungsten-oxide, a tin-oxide, a vanadium-oxide, a titanium-oxide, a molybdenum-oxide, or combinations thereof.

17. The electrochemical cell according to claim 14, wherein the carbon-containing coating comprises at least 90% by weight carbon.

18. The electrochemical cell according to claim 14, wherein the carbon-containing coating is amorphous carbon.

19. The electrochemical cell according to claim 14, wherein the cell comprises a plurality of anodes and a plurality of cathodes.

20. The electrochemical cell according to claim 14, further comprising a separator interposed between the anode and cathode.
